(19) United States
(12) Patent Application Publication
(10) Pub. No.: US 2007/0144852 A1
(43) Pub. Date: Jun. 28, 2007

(54) DYNAMIC DAMPER AND HOLLOW PROPELLER SHAFT EQUIPPED WITH SAME

(75) Inventor: Masashi FURUYA, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HOKUSHIN CORPORATION, Yokohama-shi (JP)

(21) Appl. No.: 11/616,574

(22) Filed: Dec. 27, 2006

(30) Foreign Application Priority Data
Dec. 27, 2005 (JP) 2005-374893
Jul. 25, 2006 (JP) 2006-202112

(51) Int. Cl. F16F 7/10

(52) U.S. Cl. 188/379

(57) ABSTRACT

A dynamic damper that has high lateral spring characteristics regardless of the size of a hollow propeller shaft and enables resonance characteristics to be obtained from low to high frequency ranges, wherein metal components are reduced and costs are lowered without bonding, and the dynamic damper is easily mounted. The dynamic damper has a damper mass (3) that freely fits into a hollow shaft (2) and is covered on the surface with an elastic member; mounting members (4, 5) that are disposed at the two ends of the damper mass (3) and are composed of elastic members fixed by compression inside the hollow shaft (2); and elastic connecting members (7, 8) that elastically and integrally connect the damper mass (3) to the mounting members (4, 5) so that the damper mass and mounting members have the same axis (6), and that are inclined in relation to this axis (6). The roles of the mounting members (4, 5) and the connecting members (7, 8) can thereby be divided, sheared components and compressed components play a major role among the connecting members (7, 8), and adjusting the mass and rigidity of the connecting members (7, 8) allows high lateral spring characteristics to be maintained, resonance characteristics to be achieved in a wide range of frequencies, and the dynamic damper to be easily manufactured at low cost.

### BACKGROUND OF THE INVENTION

1. Field of the Invention

The present invention relates to a dynamic damper and a hollow propeller shaft equipped with this damper, which are used to reduce the noise level of an automobile in motion. The present invention more specifically relates to a dynamic damper and a hollow propeller shaft equipped with this damper, wherein both end sides of a damper mass that freely fits into a hollow shaft are connected by an inclined connecting member to a mounting member fixed in the hollow shaft by compression, whereby the dynamic damper can be appropriately adapted to the moving characteristics of the automobile at low cost.

2. Description of the Related Art

A dynamic damper is mounted in a hollow propeller shaft provided to transmit drive force in an automobile, and is used to prevent vibration in the vehicle, to reduce the noise level of the automobile in motion, to prevent strength loss associated with metal fatigue resulting from vibrations in the hollow propeller shaft itself, and to improve durability. This dynamic damper for a hollow propeller shaft normally has at least an outer pipe 50 on which a rubber 53 is affixed to the external peripheral surface, a damper mass 51 disposed in the axial core of the outer pipe 50, and rubber mounts 52 interposed between the damper mass 51 and the outer pipe 50 to elastically connect the two together, as shown in FIG. 22. This dynamic damper is disposed inside the hollow propeller shaft to absorb and prevent vibrations that occur while the hollow propeller shaft is rotating, whereby the issue of vibration in the hollow propeller shaft is resolved.

When the hollow propeller shaft is reduced in diameter in order to conserve energy, the distance between the damper mass 51 and the outer pipe 50 inevitably grows smaller, and the rubber mounts 52 for connecting the two are reduced in width. Therefore, the rubber mounts 52 are easily damaged and durability is not guaranteed when the dynamic damper is removed from a metal die during the manufacturing process. The following known technique is employed to overcome these drawbacks.

The dynamic damper shown in FIG. 22 is normally obtained by heating a metal die to a specific temperature, subjecting the damper mass 51 and outer pipe 50 to surface and chemical treatments in advance, applying an adhesive, and then inserting the damper mass and outer pipe into the metal die, injecting a rubber material, and vulcanizing and molding the rubber. Therefore, although this dynamic damper has merits in that the damper mass 51 and the outer pipe 50 are integrated with the rubber 53 and the rubber mounts 52, a long time is required to create the damper, productivity is low, and costs tend to be high. The following known technique is employed to overcome these drawbacks.

The dynamic damper described in Japanese Laid-open Patent Application No. 2003-294025 has rubber mounts 52A covering the two ends of a damper mass 51a, and these rubber mounts 52A are composed of large-diameter parts 52a fixed inside a hollow propeller shaft 58, and small-diameter parts 52b formed integrally with the large-diameter parts 52a to contact and support the ends of the damper mass 51a, as shown in FIG. 23. The dynamic damper can thereby be fixed inside the hollow propeller shaft 58 by the large-diameter parts 52a, the outer pipe 50 in FIG. 22 is no longer necessary, a small-diameter hollow propeller shaft 58 can be used, and durability can be guaranteed.

The dynamic damper described in Japanese Patent No. 2599059 has rubber mounts 52B provided to the ends of a damper mass 51b, and these rubber mounts 52B are fixed inside a hollow propeller shaft 58 by using fixing auxiliary rings 54. The dynamic damper can thereby be fixed inside the hollow propeller shaft 58 by these fixing auxiliary rings 54, the outer pipe 50 becomes no longer necessary, a small-diameter hollow propeller shaft 58 can be used, and durability can be guaranteed.

In the dynamic damper described in Japanese Laid-open Patent Application No. 2003-262252, rubber mounts 52C are provided to one end of a damper mass 51c, and these rubber mounts 52C are connected to the radially inner surface 55a of a fixing ring 55 and are fixed inside the hollow propeller shaft 58 by this fixing ring 55. The dynamic damper can thereby be fixed inside the hollow propeller shaft 58 by this fixing ring 55, a small-diameter hollow propeller shaft 58 can be used, and durability can be guaranteed.

The dynamic damper described in Japanese Laid-open Patent Application No. 2004-108426, which is intended to deal with rising costs, is provided to the external periphery of a shaft 60, and is composed of a damper mass 51d and rubber mounts 52D press-fitted on both sides between the damper mass 51d and the shaft 60, as shown in FIG. 26.

Similarly, the dynamic damper described in Japanese Laid-open Patent Application No. 2004-156674 is composed of a damper mass 51e having two annular grooves 61 recessed radially inward in the external peripheral surface, and ring-shaped mounted rubbers 52E press-fitted and fixedly supported in the two annular grooves 61, as shown in FIG. 27. The dynamic damper is arranged inside a hollow propeller shaft 58.

Similarly, the dynamic damper described in Japanese Laid-open Patent Application No. 2002-235802 is composed of a mounting pipe 56, a damper mass 51f disposed in the axial core of the mounting pipe 56, and damper mounts 52F disposed between the mounting pipe 56 and the damper mass 51f to elastically connect the two together, as shown in FIG. 28. The dynamic damper is formed by disposing outer pipes 50 on the outer sides of the damper mounts 52F, drawing the outer pipes 50, and then press-fitting a damper mass 51f into the mounting pipe 56.

The techniques described in Japanese Laid-open Patent Application Nos. 2004-108426, 2004-156674, and 2002-235802 do not require surface treatments, chemical treatments, or adhesive coatings on the damper masses 51d, 51e, and 51f, which are metal components. Productivity can be improved, and costs can be lowered as a result.

### SUMMARY OF THE INVENTION

In the damper disclosed in Japanese Laid-open Patent Application No. 2003-294025, the portion where the rubber mounts 52A are fixed in the hollow propeller shaft 58 is integrated with the portion that exhibits resonance characteristics. Therefore, when the rubber mounts 52A are press-fitted into the hollow propeller shaft 58, compression occurs, the resonance frequency increases, and it becomes difficult to obtain resonance characteristics in a low frequency range. The rigidity of the rubber mounts 52A must be reduced in order to obtain resonance characteristics in a low frequency range, but such a reduction is limited in these materials and is difficult to accomplish in practice.

Since the damper disclosed in Japanese Patent No. 2599059 is fixed inside the hollow propeller shaft 58, separate fixing rings 54 are needed, leading to increases in cost.

Since the damper disclosed in Japanese Laid-open Patent Application No. 2003-262252 is fixed inside the hollow propeller shaft 58, separate fixing rings 55 are needed, leading to increases in cost. Additionally, the damper mass 51c has a cantilevered structure, which leads to problems with removing the rotation component.

The dynamic damper disclosed in Japanese Laid-open Patent Application No. 2004-108426 can result in increased productivity and lowered costs. However, since the portions of the rubber mounts 52D fixed to the shaft 60 are integrated with the portion that exhibits resonance characteristics, these portions become compressed, the compression affects the resonance frequency characteristics and increases resonance frequency, and it becomes difficult to obtain resonance characteristics in a low frequency range. Moreover, the rigidity of the rubber mounts 52D must be reduced in order to obtain resonance characteristics in a low frequency range, but such a reduction is limited in these materials and is difficult to accomplish in practice.

The dynamic damper disclosed in Japanese Laid-open Patent Application No. 2004-156674 can result in increased productivity and lowered costs, similar to Japanese Laid-open Patent Application No. 2004-108426, but resonance characteristics cannot be obtained in a low frequency range for the same reasons as in Japanese Laid-open Patent Application No. 2004-108426.

The dynamic damper disclosed in Japanese Laid-open Patent Application No. 2002-235802 does not require any surface treatments, chemical treatments, or adhesive coatings to the mounting pipe 56, the damper mass 51f, or the outer pipes 50, which are metal components. However, tools and press-fitting steps are required for the press-fitting of these fixtures, productivity is not increased, and it is difficult in practice to reduce costs.

In view of this, a first object of the present invention is to provide a dynamic damper that has high lateral spring characteristics, wherein resonance characteristics can be obtained in low to high frequency bands, metal components other than the damper mass can be omitted to reduce costs, and the damper can be easily mounted in the hollow propeller shaft, regardless of the size of the hollow propeller shaft. A second object of the present invention is to ensure that an elastic member supporting part is formed through the ends of the damper mass by hollowing out the damper mass, that a rubber elastic member covers the external periphery of the damper mass as a stopper, and that the functions of the dynamic damper described above can be sufficiently achieved without bonding.

The present invention has been perfected in order to achieve the objects described above, and has the following configuration.

Specifically, the present invention provides a dynamic damper comprising a damper mass that freely fits into a hollow shaft and is covered on the surface with an elastic member, mounting members that are disposed at the two ends of the damper mass and are composed of elastic members fixed by compression inside the hollow shaft, and elastic connecting members that elastically and integrally connect the damper mass to the mounting members on the two sides so that the damper mass and mounting members have the same axis, and that are inclined in relation to the axis.

The present invention provides a dynamic damper wherein the damper mass is divided in the transverse direction into a plurality of members of different weights, and the divided damper mass components are connected by rubber members.

The present invention provides a dynamic damper wherein the damper mass and the mounting members on the two sides thereof are connected by an integrated connecting member, which is connected to the damper mass via a hole provided in the axial direction of the damper mass.

The present invention provides a dynamic damper wherein the connecting parts of the integrated connecting member are five or more convex extended connecting parts at substantially equal intervals in the external peripheral surface of the damper mass.

The present invention provides a dynamic damper wherein adjacent convex extended connecting parts are connected to each other by bridging parts that are formed as a belt in a circumferential direction.

The present invention provides a dynamic damper wherein the connecting parts of the integrated connecting member are configured from the perforated connecting part and the convex extended connecting parts.

The present invention provides a dynamic damper wherein the inclination of the connecting member in relation to the axis is within a range of 45±20 degrees.

The present invention provides a dynamic damper wherein the ring diameter of one of the mounting members is less than the ring diameter of the other mounting member.

The present invention provides a dynamic damper wherein three or more notches extending in the axial direction are formed at equal intervals around the circumferences of the surfaces of the mounting members that contact the hollow shaft.

The present invention provides a dynamic damper wherein a stopper configured from an elastic member is provided to the external peripheral surface of the damper mass, the stopper does not function within the normal rotating range of the hollow shaft, and the stopper is caused to function outside the normal rotation range.

The present invention provides a hollow propeller shaft wherein concavoconvex parts are provided to the hollow shaft positioned between the inside ends of the mounting members on both sides of the dynamic damper described above, and the concavoconvex parts serve as positioning members when the dynamic damper is inserted into the hollow shaft.

The present invention provides a hollow propeller shaft wherein compressed concavoconvex parts that are shorter than the distance L between the outside ends of the mounting members are provided to the hollow shaft positioned between the outside ends of the mounting members on both sides of the dynamic damper described above, and the connecting members inclined in relation to the axis are compressed by the compressed concavoconvex parts when the dynamic damper is inserted into the hollow shaft.

In the dynamic damper of the present invention, since the damper mass fitting freely in the hollow shaft is connected to the mounting members by inclined connecting members, sheared components and compressed components play a major role among the connecting members. If the mass and rigidity of the connecting members are adjusted, resonance characteristics can be achieved in a wide range of low to high frequencies while high lateral spring characteristics are maintained. [The dynamic damper] (*2) is compressed and fixed in the hollow shaft by the elastic mounting members, irrespective of the connecting members. Therefore, the connecting members and mounting members are prevented from damage in structural terms, durability can be maintained, high lateral spring characteristics are achieved, and resonance characteristics in low to high frequency ranges can be obtained, regardless of the diameter of the hollow propeller shaft. Moreover, costs can be lowered because metal components other than the damper mass can be omitted, and [the dynamic damper] can be easily mounted in the hollow shaft.

Damper masses of different weights have different characteristic values (please specify what characteristic values), as a result of which the damper masses resonate in close frequency ranges, widening the range of resonance amplification.

The integrated connecting member joins together the inclined portions on both sides by means of a portion that passes through the hole in the damper mass, whereby the damper mass and the integrated connecting member are not bonded together, there is no need for bonding steps, and the effects of increasing productivity and lowering costs are more reliable.

The connecting parts of the integrated connecting member join together the inclined portions on both sides by means of convex extended connecting parts spread across the external peripheral surface of the damper mass, whereby the damper mass and the integrated connecting member are not bonded, and the effects described above made are more reliable. Moreover, if the hollow shaft exceeds the normal rotation range and the amplitude becomes abnormally high, the convex extended connecting parts function as stoppers, come into contact with the inner wall of the hollow shaft, and prevent the integrated connecting member from being deformed any further. Therefore, vibration is absorbed in the lateral direction in the normal rotation range of the engine, and the vibration prevention function remains the same and deformation is reduced even if the normal rotation range is greatly exceeded and acceleration greatly increases. Sufficient durability is therefore maintained.

Since the convex extended connecting parts spread across the external peripheral surface of the damper mass are connected by belt-shape bridging parts, the shapes of the convex extended connecting parts are stable and the effects described above are made more reliable.

The connecting parts of the integrated connecting member join together the inclined portions on both sides by means of a perforated connecting part and convex extended connecting parts, whereby the damper mass and the integrated connecting member are not bonded, and the effects described above are made more reliable. Moreover, the convex extended connecting parts described above provide a stopper function.

Sheared components and compressed components play a major role among the connecting members, rendering the effects described above more reliable.

The ring diameter of one mounting member is less than the ring diameter of the other mounting member, and three or more notches extending in the axial direction are formed at equal intervals around the circumferences of the surfaces of the mounting members that contact the inner periphery of the hollow shaft, whereby the mounting members can be mounted more smoothly in the hollow shaft.

When the hollow shaft in the hollow propeller shaft exceeds the normal rotation range and the amplitude becomes abnormally high, the stopper configured from an elastic member performs the intended function, comes into contact with the inner wall of the hollow shaft, and prevents the connecting members from being deformed any further. Therefore, in addition to the effects described above, durability is sufficient because vibration is absorbed in the lateral direction in the normal rotation range of the engine, and the vibration is absorbed and deformation reduced even if the normal rotation range is greatly exceeded and acceleration greatly increases. Moreover, manufacturing is made easier merely because a stopper is provided.

When the dynamic damper is inserted into the hollow shaft in the hollow propeller shaft, the concavoconvex parts determine the inserted position. The operation of mounting the dynamic damper in the hollow shaft is thereby made extremely simple, in addition to the effects described above.

When the dynamic damper is inserted into the hollow shaft in the hollow propeller shaft, the mounting members and the connecting members, particularly the connecting members, are compressed by the compressing convex parts. Therefore, the durability of the dynamic damper can be improved by the compressing action, in addition to the effects described above.

The preferred embodiments for carrying out the present invention are described hereinbelow with reference to the diagrams.

### BRIEF DESCRIPTION OF THE DRAWINGS

FIG. 1 is a cross-sectional view showing a dynamic damper of Embodiment 1 of the present invention;

FIG. 2 is a cross-sectional view showing the operation of mounting the dynamic damper of Embodiment 1 in a hollow propeller shaft;

FIG. 3 is a cross-sectional view (*3) showing the dynamic damper of Embodiment 1 as being mounted in a hollow propeller shaft;

FIG. 4 is a characteristic diagram of the frequency and resonance amplitude of the dynamic damper of Embodiment 1;

FIG. 5 is a cross-sectional view of the dynamic damper of Embodiment 1 as being mounted in a hollow propeller shaft having a unique shape;

FIG. 6 is a cross-sectional view of the dynamic damper of Embodiment 1 as being mounted in a hollow propeller shaft having a unique shape;

FIG. 7 is a cross-sectional view showing the dynamic damper in Embodiment 2 of the present invention;

FIG. 8 is a cross-sectional view showing the dynamic damper in Embodiment 3 of the present invention;

FIG. 9 is a side view showing the dynamic damper in Embodiment 4 of the present invention;

FIG. 10 is a perspective view showing the dynamic damper in Embodiment 5 of the present invention;

FIG. 11 is a cross-sectional view showing the dynamic damper in Embodiment 6 of the present invention;

FIG. 12 is a characteristic diagram of the frequency and resonance amplitude of the dynamic damper in Embodiment 6;

FIG. 13 is a cross-sectional view showing the dynamic damper in Embodiment 7 of the present invention;

FIG. 14 is a perspective view showing the dynamic damper in Embodiment 8 of the present invention;

FIG. 15 is a front view showing the dynamic damper in Embodiment 8;

FIG. 16 is a cross-sectional view along the line X-X in FIG. 15;

FIG. 17 is a perspective view showing the dynamic damper in Embodiment 9 of the present invention;

FIG. 18 is a front view showing the dynamic damper in Embodiment 9;

FIG. 19 is a cross-sectional view along the line Y-Y in FIG. 18;

FIG. 20 is a cross-sectional view showing the dynamic damper in Embodiment 10 of the present invention;

FIG. 21 shows graphs comparing the characteristics of cases with and without bonding;

FIG. 22 is a perspective view showing a conventional dynamic damper;

FIG. 23 is a cross-sectional view showing a conventional dynamic damper;

FIG. 24 is a cross-sectional view showing a conventional dynamic damper;

FIG. 25 is a cross-sectional view showing a conventional dynamic damper;

FIG. 26 is a cross-sectional view showing a conventional dynamic damper;

FIG. 27 is a cross-sectional view showing a conventional dynamic damper; and

FIG. 28 is a cross-sectional view showing a conventional dynamic damper.

### DESCRIPTION OF THE PREFERRED EMBODIMENTS

### Embodiment 1

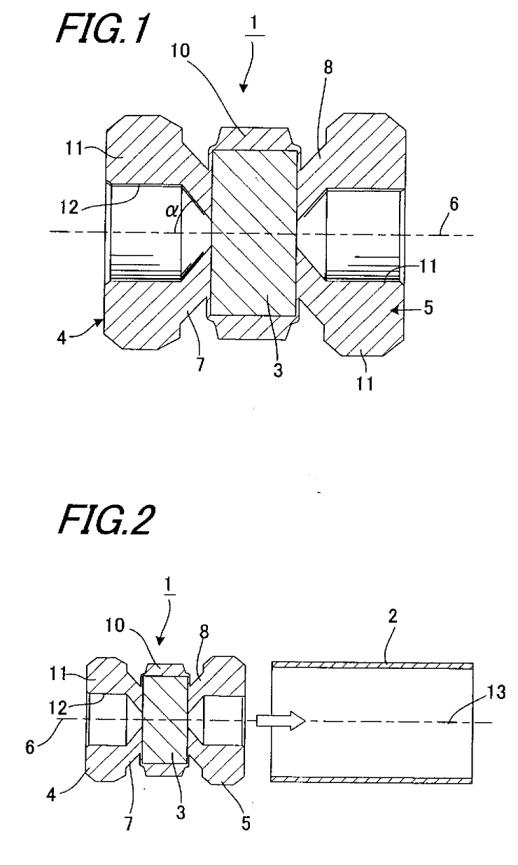

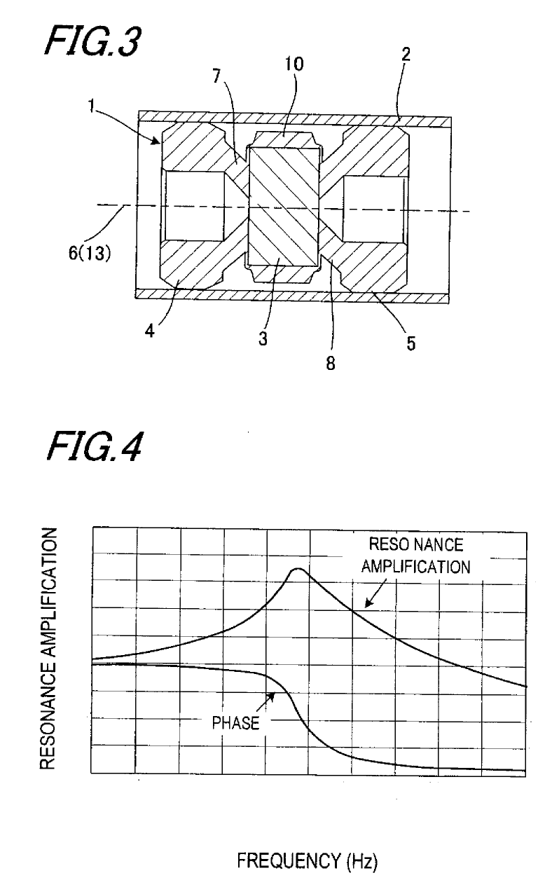

FIG. 1 is a cross-sectional view showing the dynamic damper of the present invention, FIG. 2 is a cross-sectional view showing the manner in which the dynamic damper of the present invention is mounted inside a hollow propeller shaft, and FIG. 3 is a cross-sectional view showing the dynamic damper of the present invention as being mounted inside the hollow propeller shaft.

In these diagrams, the dynamic damper 1 of the present invention has at least a damper mass 3 which freely fits into a hollow shaft 2 in a hollow propeller shaft and whose surface is covered by an elastic member; mounting members 4, 5 located at the end sides of the damper mass 3 and composed of elastic members fixed inside the hollow shaft 2 by compression; and elastic connecting members 7, 8 that integrally and elastically connect the damper mass 3 with the mounting members 4, 5 on the two sides so that the damper mass and mounting members have the same axis 6. The connecting members 7, 8 are inclined in relation to this axis 6.

Since the damper mass 3 must have a certain weight, cast iron or steel is often used for the sake of economic efficiency. The mounting members 4, 5 and connecting members 7, 8 are made of SBR (styrene-butadiene copolymer-based synthetic rubber) or natural rubber, which are both elastic materials, or of a mixture of the two. However, unlike the rubber mounts 52 in the conventional art, the mounting members 4, 5 can be regarded as equivalent to the outer pipes 50 on which the rubber 53 is affixed, and the connecting members 7, 8 can be regarded as equivalent to the rubber mounts 52.

In this embodiment, the damper mass 3 is in the shape of a disc, but this shape is not limited to a disc and may change depending on the diameter or shape of the hollow shaft 2, as is described later. A stopper 10 composed of the aforementioned elastic material is provided to the external peripheral surface of the damper mass 3, and the stopper 10 does not function within the regular rotation range of the hollow shaft 2. When the regular rotation range is exceeded, strain is generated in the elastic connecting members 7, 8, and the stopper 10 comes into contact with the inner wall of the hollow shaft 2, thereby limiting any further increases in the strain in the connecting members 7, 8 and allowing the stopper 10 to function.

The mounting members 4, 5 have disc shapes with holes 12 formed in discs 11, and are used to mount the dynamic damper 1 inside the hollow shaft 2. Specifically, the outside diameters of the discs are slightly greater than the inside diameters of the hollow shaft 2, and the mounting members 4, 5 are forcibly compressed and fixed inside the hollow shaft 2 by press-fitting. This mounting has substantially no effect on the connecting members 7, 8. The peripheral edges of the discs 11 of the mounting members 4, 5 are cut, and the dynamic damper 1 is easily press-fitted into the hollow shaft 2.

The connecting members 7, 8 are used to link the damper mass 3 and the mounting members 4, 5, and are integrated with the mounting members 4, 5 in this embodiment. Specifically, the flat surfaces on the sides of the damper mass 3 are both connected to one of the side surfaces of the discs 11 of the mounting members 4, 5 at the connecting members 7, 8, which have an inclined continuous wall shape, i.e., an umbrella shape. Therefore, sheared and compressed components play a major role among the connecting members 7, 8. Adjusting the lengths, angles, and rigidity of the connecting members 7, 8 allows resonance characteristics to be achieved in low to high frequencies while high lateral spring characteristics are maintained. The aforementioned characteristics of the connecting members 7, 8 can be obtained without being affected by the mounting members 4, 5, because the mounting members 4, 5 substantially do not affect the connecting members 7, 8 during mounting.

Since the connecting members 7, 8 have an inclined continuous wall shape, i.e., an umbrella shape, the connecting members also contribute to preventing the disc-shaped mounting members 4, 5 from coming loose when [the damper] is mounted inside the hollow shaft 2.

The angle α of inclination of the connecting members 7, 8 in relation to the axis 6 is 45±20 degrees. Sheared components and compressed components play a major role among connecting members 7, 8 having an angle α of inclination in this range, and it is possible to reliably achieve resonance characteristics in low to high frequency ranges while high lateral spring characteristics are maintained. If the angle α of inclination is less than 25 degrees, the sheared components and bending components become the main components, high lateral spring characteristics cannot be maintained, and only resonance characteristics in low frequencies can be obtained. Conversely, if the angle α of inclination is greater than 65 degrees, the compressed components become the main components and high lateral spring characteristics are obtained, but only resonance characteristics in high frequencies can be obtained. The angle α of inclination in relation to the axis 6 is restricted to 45±20 degrees for these reasons, but a more preferable angle α of inclination would be 45±10 degrees.

The dynamic damper 1 having the configuration described above is created integrally so that the damper mass 3, the mounting members 4, 5, the connecting members 7, 8, and the stopper 10 all share the same axis 6. If the mounting members 4, 5, the connecting members 7, 8, and the stopper 10 are made from the same rubber material, these members can be manufactured all at once by injection molding or the like, using a metal die. The dynamic damper 1 thus manufactured is used after having been press-fitted into the hollow shaft 2, as shown in FIGS. 2 and 3, but it is vital at this time that the axis 6 of the dynamic damper 1 coincide with the axis 13 of the hollow shaft 2.

The dynamic damper 1 having this configuration makes it possible to obtain a frequency range in which effective vibration-absorbing effects can be expected, as shown in FIG. 4. If the lengths, angles, and rigidity of the connecting members 7, 8 are adjusted, the frequency range can be moved to the right or left along the horizontal axis, and resonance characteristics from low to high frequency ranges can be achieved while high lateral spring characteristics are maintained.

The following is a description of the operation of the dynamic damper 1 having the configuration described above.

First, a dynamic damper 1 is selected that is compatible with the diameter and rotating speed of the hollow shaft 2 of the hollow propeller shaft, and the dynamic damper 1 is mounted by press-fitting inside the hollow shaft 2. The axis 6 of the mounted dynamic damper 1 coincides with the axis 13 of the hollow shaft 2 at this time. Sheared and compressed components play a major role among the connecting members 7, 8 of the dynamic damper 1 because the mounting members 4, 5 are compressed and fixed inside the hollow shaft 2 irrespective of the connecting members 7, 8. As a result, resonance characteristics in a low to high frequency range can be achieved and freedom of design is significantly increased while high lateral spring characteristics are maintained. Moreover, durability can be maintained, metal components other than the damper mass can be omitted, and costs can be lowered because the connecting members and mounting members are prevented from being structurally damaged even if the hollow propeller shaft is small in diameter.

Next, when the dynamic damper having the configuration described above comes slightly out of alignment with the axis of the hollow propeller shaft, centrifugal force comes into effect as the hollow propeller shaft rotates. If the hollow propeller shaft rotates within a normal rotation range; for example, at 5000 rpm, there is little strain on the connecting members 7, 8, the stopper 10 of the damper mass 3 does not come into contact with the inner wall of the hollow shaft 2, and a low noise level is maintained in the hollow propeller shaft. If the hollow propeller shaft exceeds the normal rotation range and rotates, e.g., at 7000 rpm, the connecting members 7, 8 are subjected to a great amount of strain, the stopper 10 comes into contact with the inner wall of the hollow shaft 2, and the connecting members 7, 8 are not strained any further. Durability is ensured, and a low noise level is maintained in the hollow propeller shaft.

FIG. 5 shows the shape of the hollow shaft 2 in the hollow propeller shaft. With this shape, the hollow shaft 2 is provided with concavoconvex parts 14 in advance, and these parts are positioned between the inner side ends of the mounting members 4, 5 on the two sides when the dynamic damper 1 is mounted in the hollow shaft 2. These concavoconvex parts 14 act as positioning members when the dynamic damper 1 is mounted inside the hollow shaft 2. The concavoconvex parts 14 can thereby determine the press-fitted position when the dynamic damper 1 is press-fitted into the hollow shaft 2, and the mounting operation is made extremely simple.

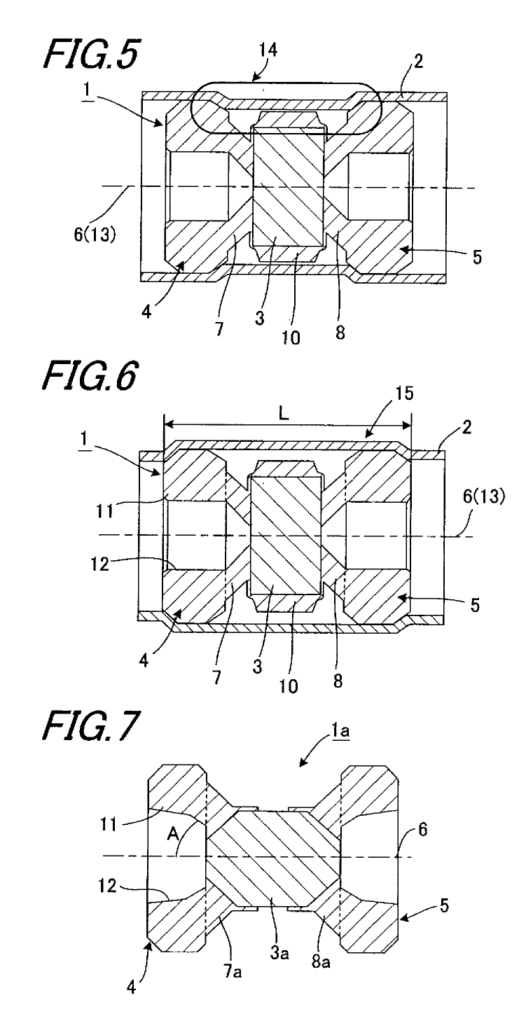

FIG. 6 shows another shape for the hollow shaft 2. This shape has compressed concavoconvex parts 15, which are shorter than the distance L between the external side ends of the mounting members 4, 5, and which are provided to the hollow shaft 2 in advance. The shaft is positioned between the external side ends of the mounting members 4, 5 on the two sides when the dynamic damper 1 is mounted in the hollow shaft 2. The compressed concavoconvex parts 15 compress the dynamic damper 1 when the dynamic damper 1 is press-fitted into the hollow shaft 2. The mounting members 4, 5 and connecting members 7, 8, particularly the connecting members 7, 8, are thereby compressed, and the durability of the dynamic damper 1 can be improved.

### Embodiment 2

FIG. 7 shows another dynamic damper 1a of the present invention, and this dynamic damper 1a differs from the dynamic damper 1 shown in FIGS. 1 through 4 in that the damper mass 3a has the shape of a rugby ball, and the connecting members 7a, 8a are accordingly bent in the end surfaces facing the damper mass 3a. In FIG. 7, the reference symbol A indicates the angles between the connecting members 7a, 8a and the axis. The configuration and operation are otherwise identical to those of the dynamic damper 1 shown in FIGS. 1 through 4, and the same reference symbols are therefore used in the drawings, and descriptions thereof are omitted.

### Embodiment 3

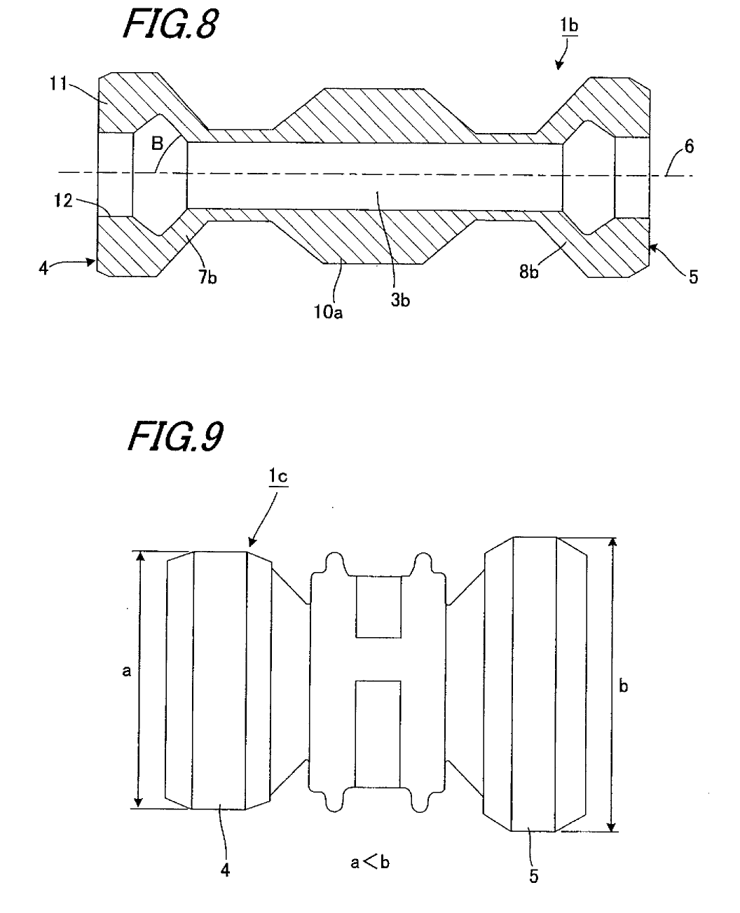

FIG. 8 shows another dynamic damper 1b of the present invention, and this dynamic damper 1b differs from the dynamic damper 1 shown in FIGS. 1 through 4 in that the damper mass 3b has the shape of a rod, and the end surfaces of the connecting members 7b, 8b on the sides facing the damper mass 3b are bent along the sides of the damper mass 3b and are joined to the stopper 10a. In FIG. 8, the reference symbol B indicates the angles between the connecting members and the axis. The configuration and operation are otherwise identical to those of the dynamic damper 1 shown in FIGS. 1 through 4, and the same reference symbols are therefore used in the drawings, and descriptions thereof are omitted.

### Embodiment 4

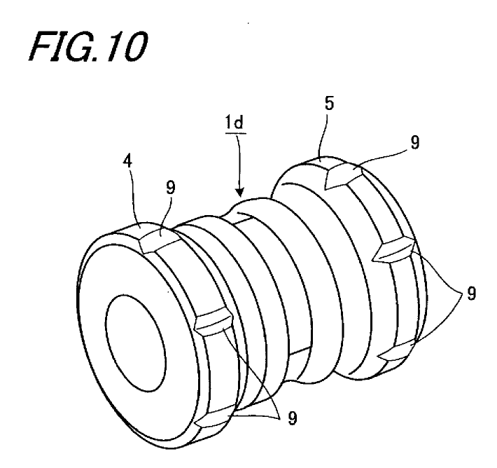

FIG. 9 shows another dynamic damper 1c of the present invention, and this dynamic damper 1c differs from the dynamic damper 1 shown in FIGS. 1 through 4 in that the ring diameter a of one mounting member 4 (5) is smaller than the ring diameter b of the other mounting member 5 (4). As a result of the ring diameter of one mounting member being smaller than the ring diameter of the other mounting member, the damper is more easily mounted in the hollow shaft and the operation can be performed with greater ease if the damper is mounted in the hollow shaft from the side of the smaller mounting member. The ring diameter a of the smaller mounting member 5 (4) can be slightly greater than the inside diameter of the hollow shaft. The dynamic damper 1c can be mounted in a compressed state inside the hollow shaft due to the elasticity of the rubber or to the action of the oil applied over the external peripheral surface of the mounting members, even if the ring diameter b of the mounting member 4 (5) is larger than the diameter a.

### Embodiment 5

FIG. 10 shows another dynamic damper 1d of the present invention, and this dynamic damper 1d differs from the dynamic damper 1 shown in FIGS. 1 through 4 in that three or more notches 9 are formed extending in the axial direction at equal intervals around the circumference of the surfaces of the mounting members 4, 5 that contact the hollow shaft 2. The notches 9 in the dynamic damper 1d also contribute to the ease of mounting the damper in the hollow shaft 2, and the notches 9 reduce the surface area of contact between the internal periphery of the hollow shaft 2 and the external periphery of the mounting members 4, 5 of the dynamic damper 1d when the damper is mounted, thus making it easier for the damper to be mounted. It is important that the shapes of the notches 9 extend in the axial direction at equal intervals around the circumference of the contact surface. The number of notches differs depending on the size of the dynamic damper id and the width and depth of the notches 9, but it is normally preferable that three or more notches be formed at equal intervals around the circumference. The compression force on the mounting members 4, 5 is reduced if there are too many notches 9, such as 20 or more, and a suitable number should therefore be employed within a range that does not reduce the compression force on the mounting members 4, 5, e.g., three or more and 20 or less.

### Embodiment 6

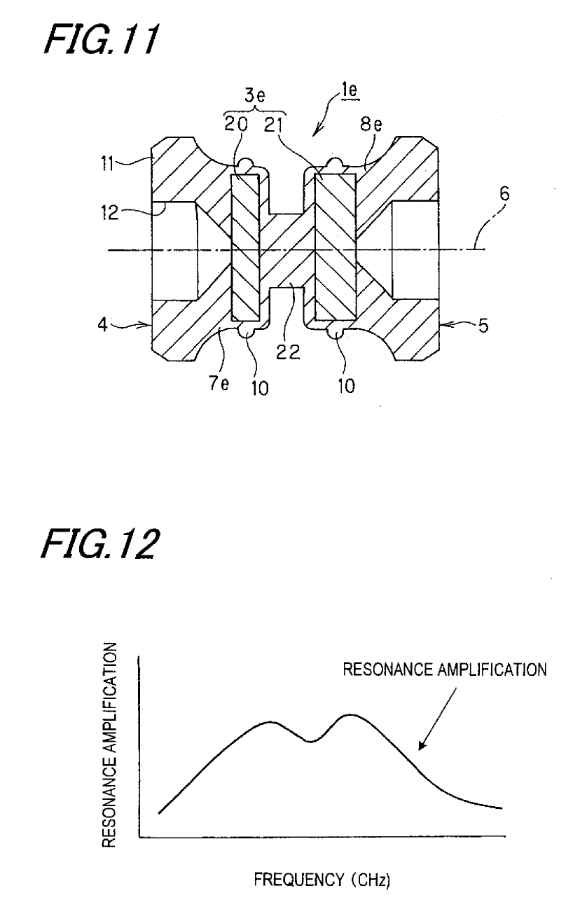

FIG. 11 shows another dynamic damper 1e of the present invention, and this dynamic damper 1e differs from the dynamic damper 1 shown in FIGS. 1 through 4 in that the damper mass 3e is separated in the transverse direction into a light mass 20 and a heavy mass 21 of differing weights, and the separated light mass 20 and heavy mass 21 are connected by a rubber member 22. The light mass 20 and the heavy mass 21 are thereby caused to resonate in close frequency ranges, and an effect of increasing the width of resonance amplitude is achieved, as shown in FIG. 12. The configuration and operation are otherwise identical to those of the dynamic damper 1 shown in FIGS. 1 through 4, and the same reference symbols are therefore used in the drawings, and descriptions thereof are omitted.

### Embodiment 7

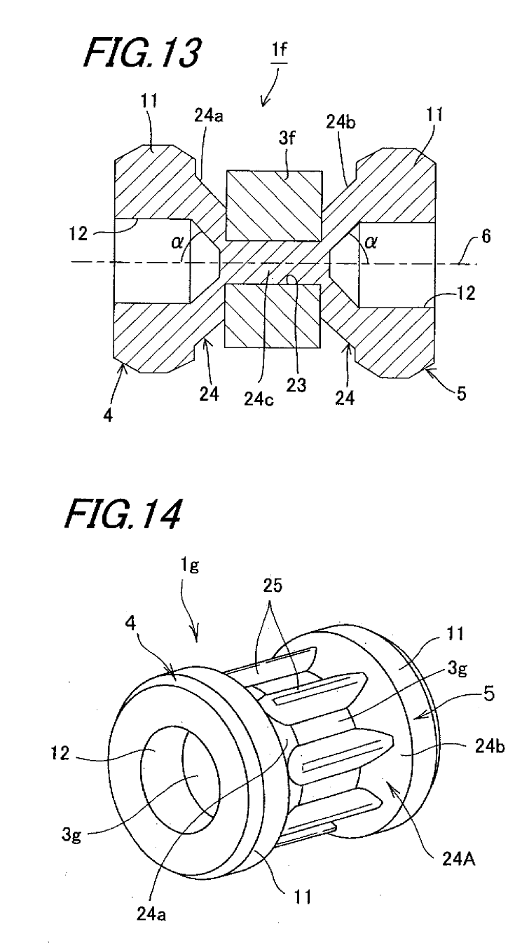

FIG. 13 shows another dynamic damper 1f of the present invention, and this dynamic damper if differs from the dynamic damper 1 shown in FIGS. 1 through 4 in that the damper mass 3f and the mounting members 4, 5 on the two sides thereof are connected by an integrated connecting member 24, which is connected to the damper mass 3f via a hole 23 formed in the axial direction of the damper mass. The connective part of this integrated connecting member 24 elastically connects the damper mass 3f to the mounting members 4, 5 on the two sides so that the damper and mounting members have the same axis 6. The connecting member also has inclined connecting parts 24a, 24b that are inclined in relation to the axis 6, and perforated connecting parts 24c that link the inclined connecting parts via the hole 23 in the damper mass 3f. These parts of the connecting member are integrally molded.

The dynamic damper 1f having the configuration described above is formed integrally so that the damper mass 3f, the mounting members 4, 5, and the inclined connecting parts 24a, 24b of the integrated connecting member 24 all share the same axis 6. If the mounting members 4, 5 and the integrated connecting member 24 are made from the same rubber material, these members can be manufactured all at once by injection molding or the like, using a metal die without performing any bonding. There is also no need for the damper mass 3f, which is a metal component, to be subjected to a surface treatment, chemical treatment, or adhesive coating during bonding. The dynamic damper 1f thus manufactured is used after having been press-fitted into the hollow shaft 2, as shown in FIGS. 2 and 3, but it is vital at this time that the axis 6 of the dynamic damper 1 coincide with the axis 13 of the hollow shaft 2. This dynamic damper if may also have concavoconvex parts 15 and compressed concavoconvex parts 16 provided in advance to the hollow shaft 2, similar to the damper in FIGS. 5 and 6, to improve positioning and durability. The configuration and operation are otherwise identical to those of the dynamic damper 1 shown in FIGS. 1 through 4, and the same reference symbols are therefore used in the drawings, and descriptions thereof are omitted.

### Embodiment 8

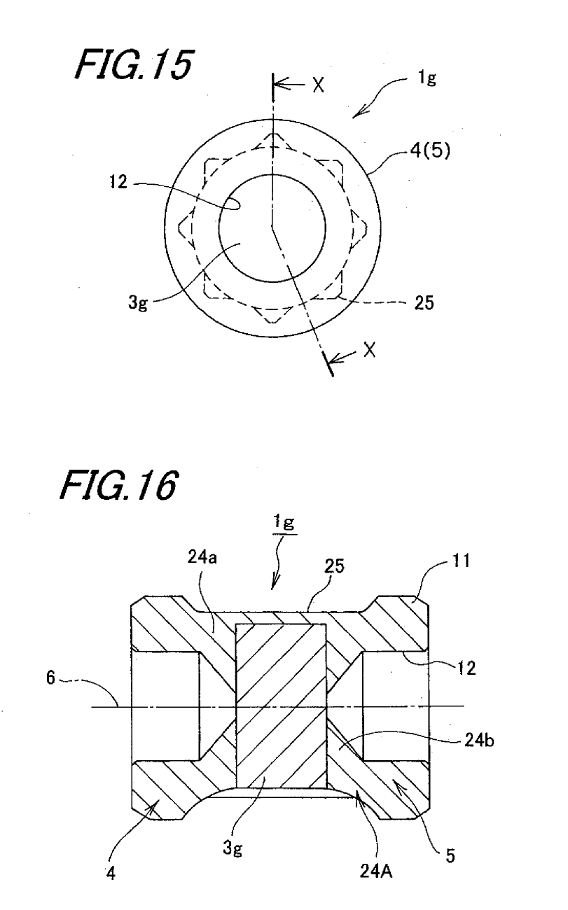

FIGS. 14 through 16 show another dynamic damper 1g of the present invention, and this dynamic damper 1g differs from the dynamic damper if shown in FIG. 13 in that the damper mass 3g has no hole 23, and therefore has no perforated connecting part 24c. Instead, the external peripheral surface of the damper mass 3g has at least five convex extended connecting parts 25 at substantially equal intervals, constituting an integrated connecting member 24A, and these convex extended connecting parts 25 join the inclined connecting parts 24a, 24b on the two sides together. Since the inclined connecting parts 24a, 24b on the two sides are joined together by the convex extended connecting parts 25, whereby the mounting members 4, 5 on the two sides are connected to each other, the damper mass 3g and the integrated connecting member 24A do not need to be bonded.

When the hollow shaft 2 exceeds a normal rotation range and the amplitude becomes abnormally high, strain is generated in the inclined connecting parts 24a, 24b on the two sides, the convex extended connecting parts 25 come into contact with the inner wall of the hollow shaft 2 and function as stoppers, and the inclined connecting parts 24a, 24b on the two sides of the integrated connecting member 24A are not deformed any further. Therefore, durability is sufficient because vibration is absorbed in the lateral direction in the normal rotation range of the engine, and the vibration is absorbed and deformation reduced even if the normal rotation range is greatly exceeded and acceleration greatly increases. The configuration and operation are otherwise identical to those of the dynamic damper 1 shown in FIG. 13, and the same reference symbols are therefore used in the drawings, and descriptions thereof are omitted.

### Embodiment 9

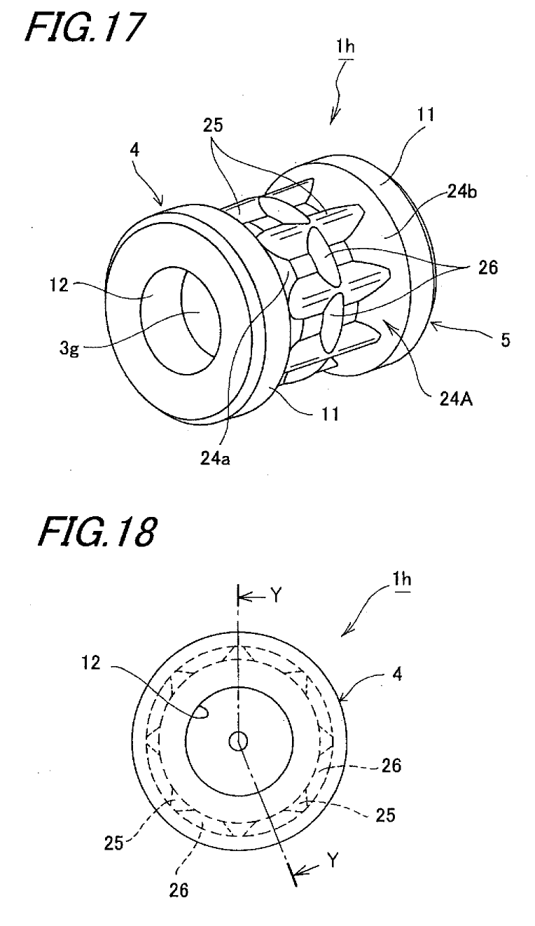

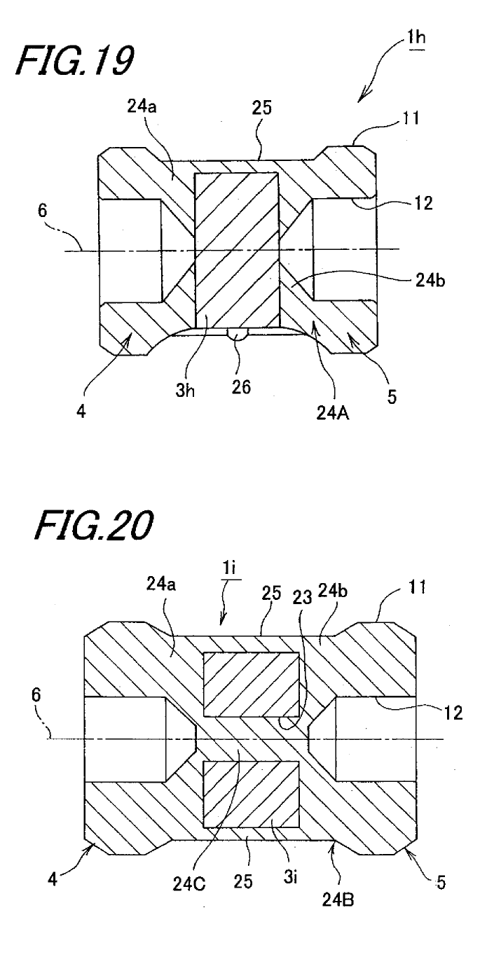

FIGS. 17 through 19 show the configuration of a dynamic damper 1h, which is an aspect of the dynamic damper 1g shown in FIGS. 14 through 16. In this dynamic damper 1h, adjacent convex extended connecting parts 25 are connected to each other by bridging parts 26 that form a belt around the circumferential direction. These bridging parts 26 stabilize the shapes of the convex extended connecting parts 25 by connecting adjacent convex extended connecting parts 25 to each other, and the bridging parts are effective in further improving the function of the dynamic damper 1h of the present invention. It is preferable for such an integrated connection that the bridging parts be formed from the same material as the convex extended connecting parts 25. The shapes of the bridging parts 26 are not particularly limited, but in order for the aforementioned objects to be more effective, it is preferable that the bridging parts be formed as a belt centered in the axial centers of the convex extended connecting parts 25, and that the height of the bridging parts be substantially the same as the height of the convex extended connecting parts 25. The term “belt” as used herein to refer to the shape of the bridging parts 26 does not necessarily mean a flat plate shape, and may also denote a rod shape or solid shape as shown in FIGS. 17 through 19. The configuration and operation are otherwise identical to those of the dynamic damper 1f shown in FIG. 13 and those of the dynamic damper 1g shown in FIGS. 14 through 16, and the same reference symbols are therefore used in the drawings, and descriptions thereof are omitted.

### Embodiment 10

FIG. 20 shows another dynamic damper 1i of the present invention, and this dynamic damper 1i differs from the dynamic damper if shown in FIG. 13 in that the damper mass 3i has a hole 23, and therefore also has a perforated connecting part 24c. Moreover, the external peripheral surface of the damper mass 3i has at least five convex extended connecting parts 25 at substantially equal intervals, constituting an integrated connecting member 24B, and the perforated connecting part 24c and convex extended connecting parts 25 connect the inclined connecting parts 24a, 24b on the two sides together. Since the inclined connecting parts 24a, 24b on two sides are connected to each other by the perforated connecting part 24c and the convex extended connecting parts 25 of the integrated connecting member 24B, and the mounting members 4, 5 on the two sides are connected together, the damper mass 3i and the integrated connecting member 24B are not bonded together, and the convex extended connecting parts 25 also function as stoppers as described above. Specifically, Embodiment 10 is a combination of Embodiments 7 and 8. The configuration and operation are otherwise identical to those of the dynamic damper 1f shown in FIG. 13 and those of the dynamic damper 1g shown in FIGS. 14 through 16, and the same reference symbols are therefore used in the drawings, and descriptions thereof are omitted.

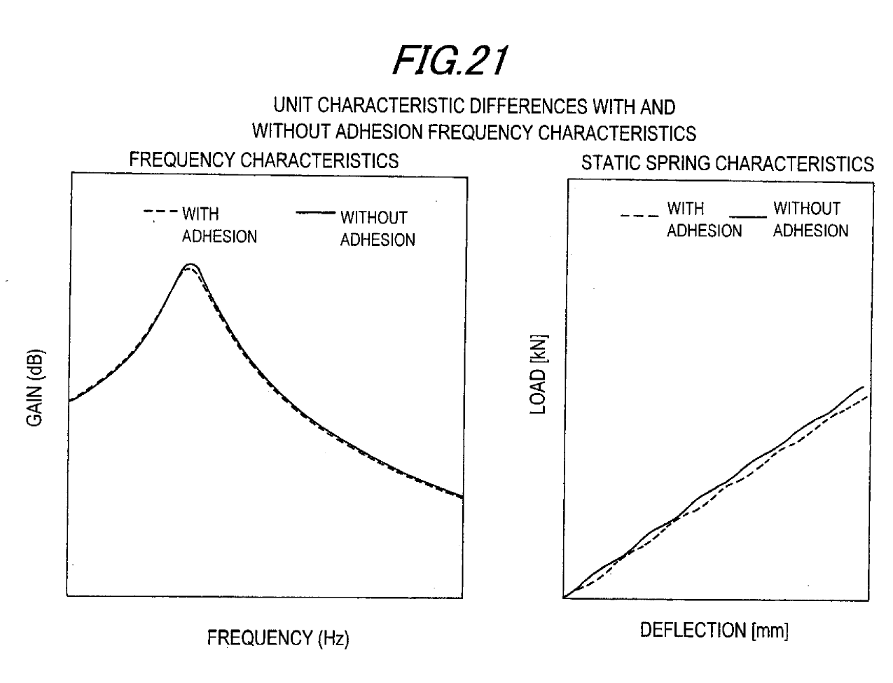

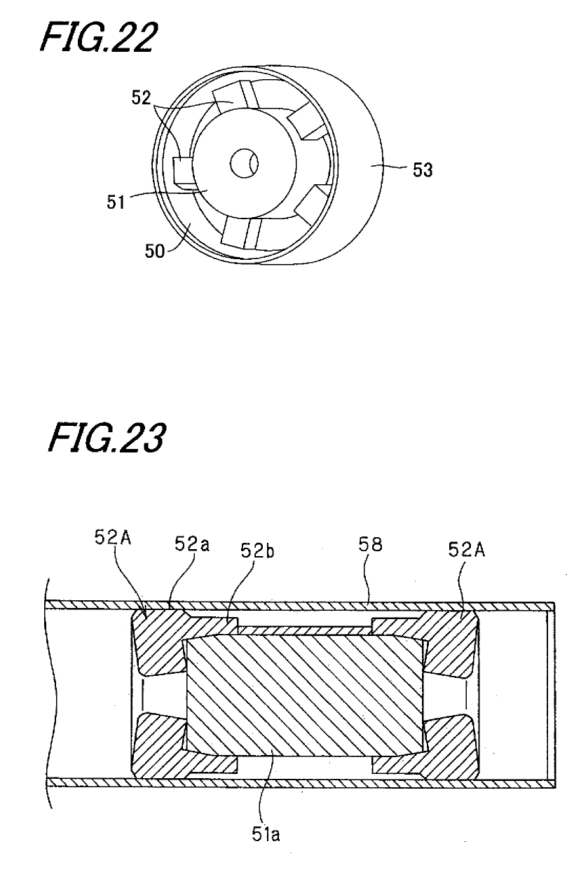

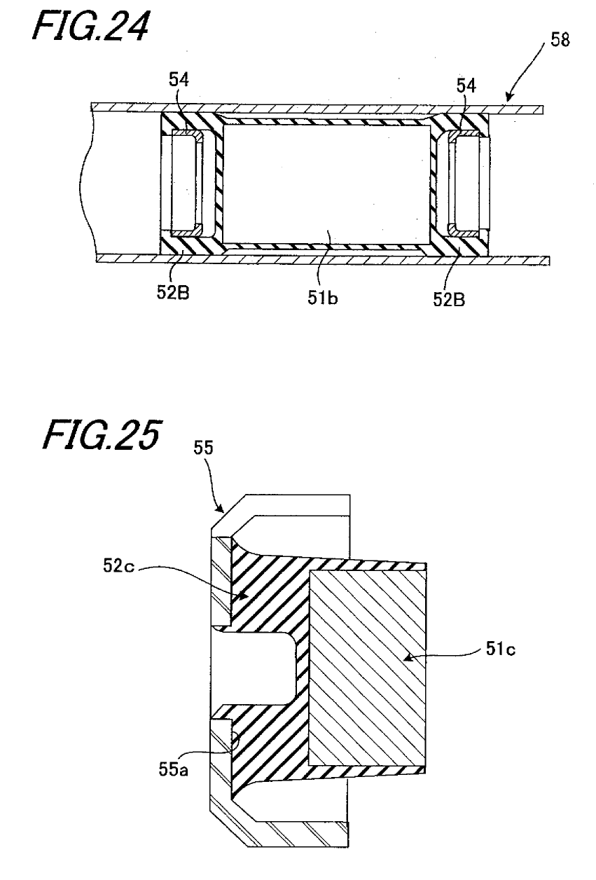

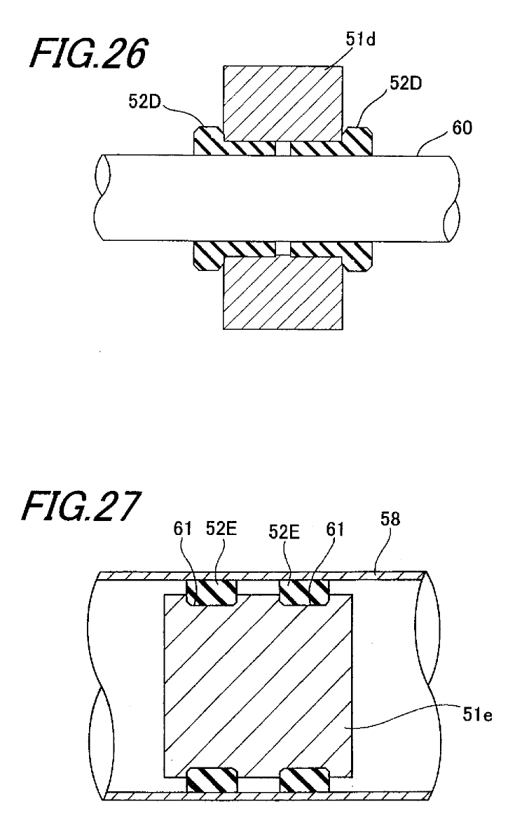

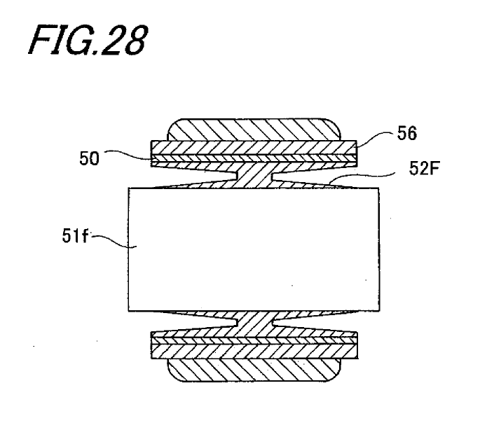

FIG. 21 shows graphs comparing the frequency characteristics and static spring characteristics of the bond-free dynamic dampers 1f, 1g, 1h, and 1i of the present invention with the frequency characteristics and static spring characteristics of a bonded dynamic damper. As can be seen from FIG. 21, it is clear that the specific configuration allows the dynamic damper of the present invention to exhibit substantially the same frequency characteristics and static spring characteristics as a dynamic damper configured with bonding.

Embodiments 1 through 10 of the present invention were described above, but the specific configuration is not limited to these options alone, and it should be apparent that modifications can be made within a range that does not deviate from the scope of the present invention.

### INDUSTRIAL APPLICABILITY

The dynamic damper of the present invention is easily manufactured without bonding, and has high lateral spring characteristics regardless of the size of the hollow propeller shaft. The present invention is highly practical in cases in which resonance characteristics in low to high frequency ranges are desired, and is extremely practical particularly in cases in which the hollow propeller shaft is small in diameter and rotates at high speeds.

1. A dynamic damper, comprising:
a damper mass that freely fits into a hollow shaft and is covered on the surface with an elastic member;
mounting members that are disposed at the two ends of the damper mass and are composed of elastic members fixed by compression inside said hollow shaft; and
elastic connecting members that elastically and integrally connect said damper mass to the mounting members on the two sides so that the damper mass and mounting members have the same axis, and that are inclined in relation to said axis.

2. The dynamic damper according to claim 1, wherein
said damper mass is divided in the transverse direction into a plurality of members of different weights; and
the divided damper mass components are connected by rubber members.

3. The dynamic damper according to claim 1 or 2, wherein said damper mass and the mounting members on the two sides thereof are connected by an integrated connecting member, which is connected to said damper mass via a hole provided in the axial direction of the damper mass.

4. The dynamic damper according to claim 1 or 2, wherein the connecting parts of said integrated connecting member are five or more convex extended connecting parts at substantially equal intervals in the external peripheral surface of the damper mass.

5. The dynamic damper according to claim 4, wherein adjacent convex extended connecting parts are connected to each other by bridging parts that are formed as a belt in a circumferential direction.

6. The dynamic damper according to claim 1 or 2, wherein the connecting parts of said integrated connecting member are configured from said perforated connecting part and said convex extended connecting parts.

7. The dynamic damper according to claim 1 or 2, wherein the inclination of said connecting member in relation to said axis is within a range of 45±20 degrees.

8. The dynamic damper according to claim 1 or 2, wherein the ring diameter of one of said mounting members is less than the ring diameter of the other mounting member.

9. The dynamic damper according to claim 1 or 2, wherein three or more notches extending in the axial direction are formed at equal intervals around the circumferences of the surfaces of said mounting members that contact the hollow shaft.

10. The dynamic damper according to claim 1 or 2, wherein
a stopper configured from an elastic member is provided to the external peripheral surface of said damper mass;
said stopper does not function within the normal rotating range of said hollow shaft; and
said stopper is caused to function outside the normal rotation range.

11. A hollow propeller shaft, wherein
concavoconvex parts are provided to said hollow shaft positioned between the inside ends of said mounting members on both sides of the dynamic damper according to claim 1 or 2; and
the concavoconvex parts serve as positioning members when said dynamic damper is inserted into said hollow shaft.

12. A hollow propeller shaft, wherein
compressed concavoconvex parts that are shorter than the distance L between the outside ends of said mounting members are provided to said hollow shaft positioned between the outside ends of said mounting members on both sides of the dynamic damper according to claim 1 or 2; and
the connecting members inclined in relation to the axis are compressed by said compressed concavoconvex parts when said dynamic damper is inserted into said hollow shaft.
